(19) United States
(12) Patent Application Publication
(10) Pub. No.: US 2017/0015385 A1
(43) Pub. Date: Jan. 19, 2017

(54) BICYCLE PEDAL

(71) Applicant: VP Components Co., Ltd., Taichung City (TW)

(72) Inventor: WEN-HWA LIN, Taichung City (TW)

(21) Appl. No.: 15/211,710

(22) Filed: Jul. 15, 2016

(30) Foreign Application Priority Data
Jul. 17, 2015 (TW) 104123317
Mar. 18, 2016 (TW) 105108406

(51) Int. Cl. B62M 3/08

(52) U.S. Cl. CPC B62M 3/08

(57) ABSTRACT

A bicycle pedal which is rotatably installed on a crank of a bicycle includes a pedal body and an axle. The pedal body includes an axle bore transversely passing through two ends thereof. The axle is formed in a straight column shape and passes through the axle bore. The axle is provided with a first end and a second end. The first end is screwedly mounted to the crank. The second end is provided with a blocking portion resisting against an outer edge of the pedal body. The pedal body rotates against the axle. A tool driving portion is disposed on an outer side of the second end for a tool to drive. With such configuration, the first end is fastened to be attached to the crank or loosened to be detached from the crank.

### BACKGROUND OF THE INVENTION

1. Field of the Invention

The present invention relates to bicycle assemblies, and more particularly, to a bicycle pedal.

2. Description of the Related Art

A traditional bicycle pedal is fastened on a bicycle crank and comprises a pedal body, an axle, a self-lubricating sleeve, a bearing unit, and a positioning limiting unit. The pedal body includes an axle bore passing therethrough. An inner end of the axle is attached to the crank, an outer end of the axle passes through the axle bore. The self-lubricating sleeve and the bearing unit are disposed between the axle and the pedal body. The position limiting unit is disposed at the outer end of the axle. With such configuration, when the pedal body and the axle axially move against each other, the position limiting unit prevents the pedal body from detaching from the axle.

Regarding the known bicycle pedal aforementioned, for achieving a stable installation, the axle is usually formed in a cone shape tapering toward the direction away from the crank. However, such a cone shape often internally causes the center of the pedal body to be structurally weak. Also, the amount of the internal components of such pedal body is relative large, causing a higher cost of the overall bicycle pedal.

Furthermore, when the bicycle pedal is to be installed on the crank or needs to be uninstalled from the crank for components replacement due to damage, a tool is required for being used to conduct the installation or uninstallation from an inner end of the crank, failing to meet the convenience of usage. In other words, the installation and uninstallation operation of such pedal are not efficiently conducted.

Therefore, an improved bicycle pedal is needed to overcome the known disadvantages above.

### SUMMARY OF THE INVENTION

For improving the aforementioned issues, embodiments of the present invention disclose a bicycle pedal having a straight-column shaped axle, which enhanced the structural strength of the pedal body and facilitates the installation and uninstallation operation of the bicycle pedal against a crank of the bicycle.

For achieving the objectives, embodiment of the present invention provides a bicycle pedal rotatably installed on a crank of a bicycle, comprising:
a pedal body including an axle bore transversely passing through two ends thereof; and
an axle formed in a straight column shape, passing through the axle bore, and provided with a first end and a second end, the first end screwedly mounted to the crank, the second end including a blocking portion resisting against an outer edge of the pedal body, the pedal body rotating against the axle, and a tool driving portion disposed on an outer side of the second end.

Also, a resilient member is disposed on an inner periphery of the axle bore, and the resilient member includes a through hole through where the axle passes.

Also, the resilient member is allowed to be a spring, such that the axle and the resilient member contact each other by multiple contact points therebetween.

Also, embodiments of the present invention further comprise a friction-resisting piece mounted around the first end of the axle for preventing the friction between the pedal body and the crank.

Also, the tool driving portion is formed in a hexagonal bore by where a hexagonal wrench drives.

With such configuration, the main objective achieved by the present invention is that the axle is formed in a straight column, thus enhancing the structural strength of the overall pedal body.

Another objective achieved by the present invention is that by use of a hexagonal wrench driving the second end of the tool driving portion, the first end of the axle is optionally fastened to the crank or loosened from the crank, facilitating the installation and uninstallation of the bicycle pedal and meeting the convenience of usage.

Another objective achieved by the present invention is that the friction-resisting piece is mounted around the first end of the axle, such that the friction-resisting piece is disposed between the pedal body and the crank for preventing the friction therebetween and decreasing the wearing possibility of the components.

Another objective achieved by the present invention is that the inner periphery of the axle bore is provided with a resilient member through where the axle passes. During the user pedaling, a vibration absorption and buffering effect is achieved.

Another objective achieved by the present invention is that due to the disposition of the resilient member, the axle and the resilient member contact each other by multiple contact points, such that the resilient member substitutes a traditional bearing. Therefore, the amount of components of the embodiment provided by the present invention is relatively less than the components amount of the known bicycle pedal, thus reducing the overall cost and meeting the economic demand.

Furthermore, embodiments of the present invention provide another kind of bicycle pedal, comprising:
a pedal body including an axle bore transversely passing through two ends thereof;
a lining tube disposed in the axle bore and integrally molded with the pedal body, the lining tube including a smooth inner bore arranged in axial alignment with the axle bore; and
an axle passing through the inner bore, enabling the pedal body to rotate against the axle, and provided with a first end and a second end opposite to the first end, the first end including a threaded section and screwedly mounted to a crank of a bicycle, the second end including a blocking portion resisting against an end of the lining tube away from the crank, the second end further including a tool driving portion.

As the lining tube integrally molded with the pedal body, additional bearing structure is omitted during the installation of the pedal body, thus simplifying the components and facilitating the installation process.

### BRIEF DESCRIPTION OF THE DRAWINGS

FIG. 1 is a perspective view of the bicycle pedal in accordance with the embodiment of the present invention.

FIG. 2 is an exploded view of the bicycle pedal in accordance with the embodiment of the present invention.

FIG. 3 is a front view of the bicycle pedal, illustrating that the tool driving portion is formed in a hexagonal bore.

FIG. 4 is a sectional view of the bicycle pedal in accordance with the embodiment of the present invention.

FIG. 5 is a schematic view illustrating the operation status of the bicycle pedal wherein the tool driving portion is driven by a tool.

FIG. 6 is a perspective view of the bicycle pedal in accordance with another embodiment provided by the bicycle pedal.

FIG. 7 is an exploded view of the bicycle pedal in accordance with another embodiment provided by the bicycle pedal.

FIG. 8 is a sectional view of the bicycle pedal in accordance with another embodiment provided by the bicycle pedal.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

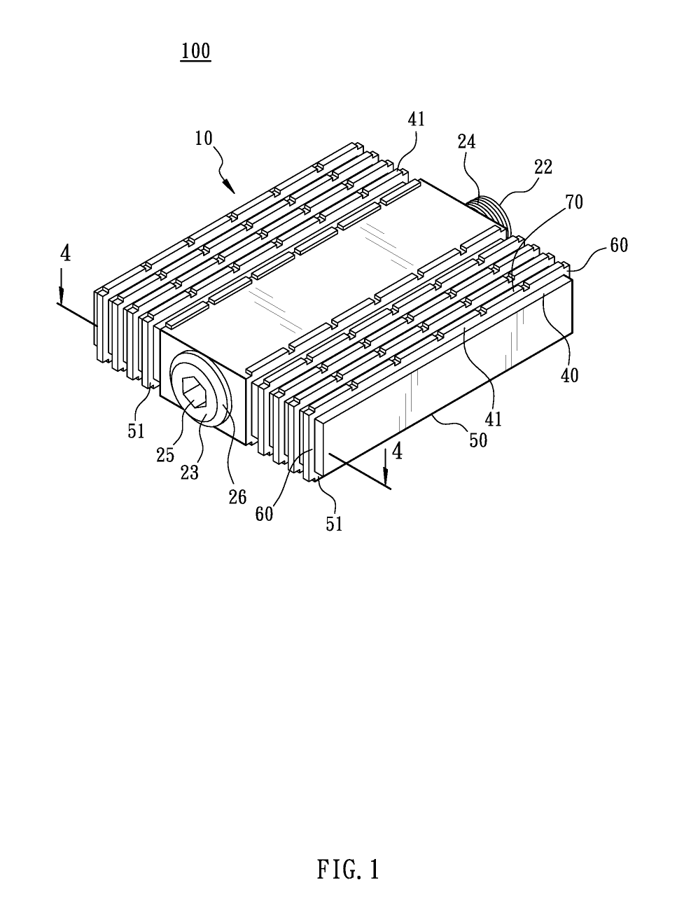

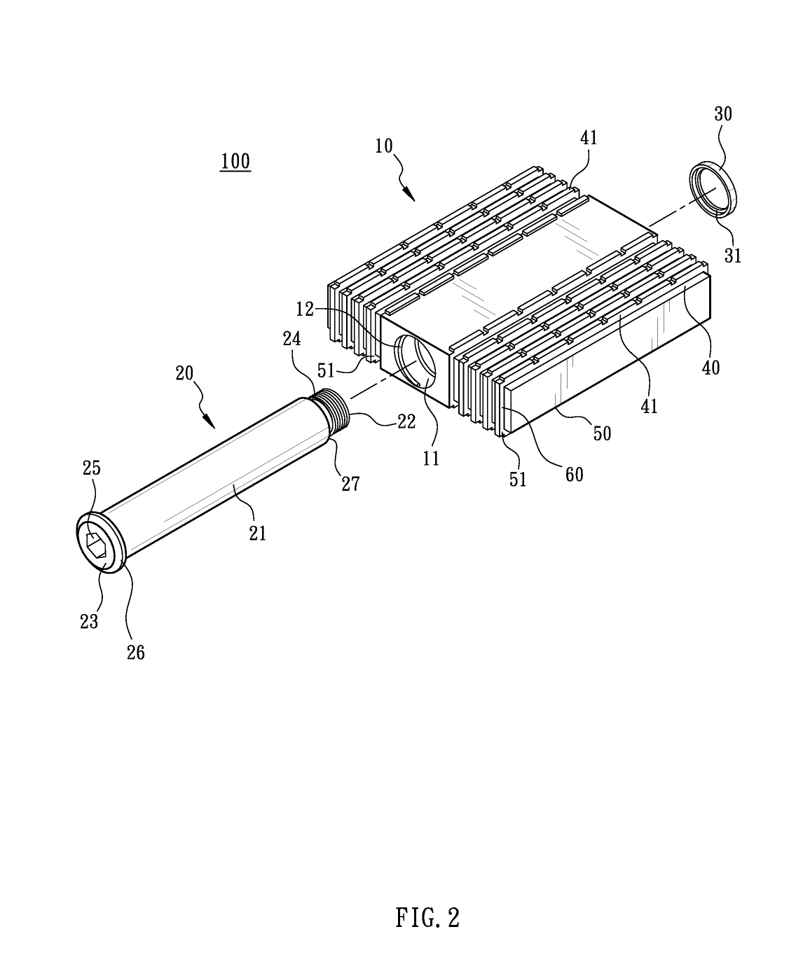

Referring to FIG. 1 to FIG. 5, embodiments of the present invention provide a bicycle pedal 100 rotatably installed on a crank 200 of a bicycle. The bicycle pedal 100 comprises a pedal body 10 and an axle 20.

The pedal body 10 is made of plastic material and provided with a straight axle bore 11 transversely passing through two ends of the pedal body 10. The inner periphery of the axle bore 11 includes a resilient member 12, as shown by FIG. 4. Preferably, the resilient member 12 is a spring which is provided with a through hole and integrally molded with the axle bore 11 when the pedal body 10 is formed by injection molding.

The axle 20 is hollow and formed in a straight column shape, so as to be inserted into the through hole of the resilient member 12, whereby the axle 20 is inserted in the axle bore 11. Also, the axle 20 and the resilient member 12 contact each other by multiple contact points therebetween. The axle 20 includes a straight section 21 with a first end 22 and a second end 23 disposed at two ends of the straight section 21. The first end 22 and the second end 23 protrude from the pedal body 10; the straight section 21 is disposed in the axle bore 11 and surrounded by the resilient member 12.

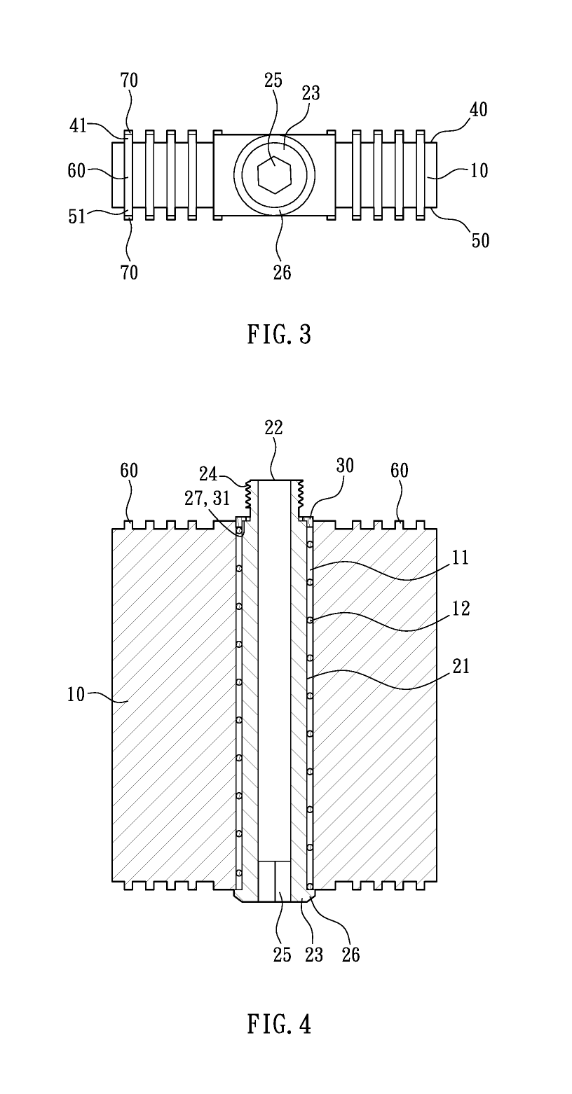

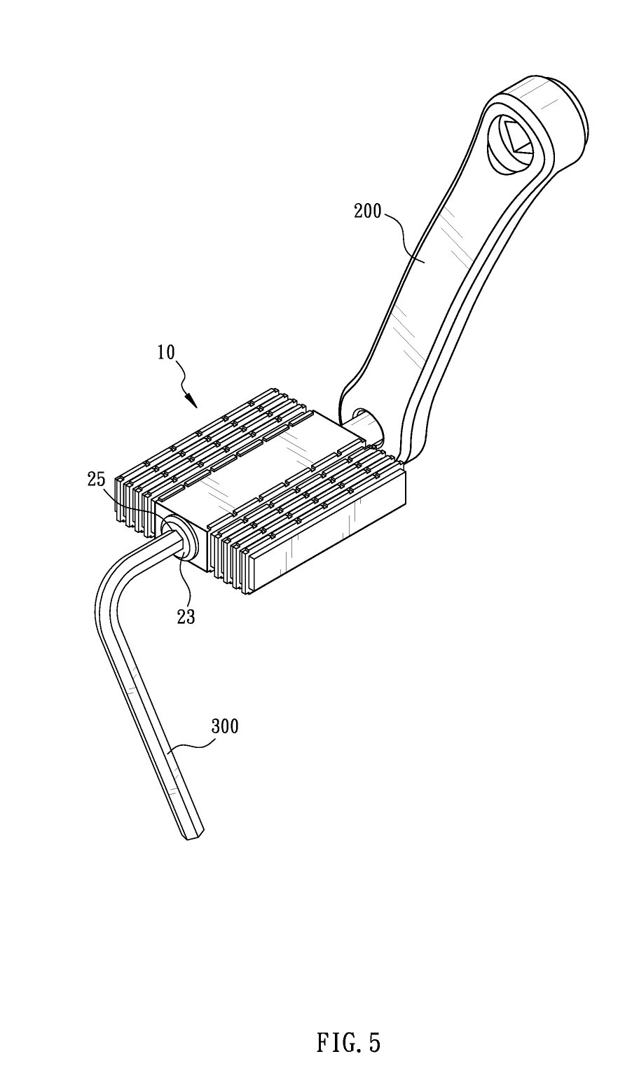

The outer diameter of the first end 22 is smaller than the diameter of the straight section 21 and provided with a threaded section 24 which is allowed to be screwedly mounted to the crank 200. The outer diameter of the second end 23 is larger than the diameter of the straight section 21, so as to form a blocking portion 26 resisting against the outer edge of the pedal body 10, thereby preventing the pedal body 10 from detaching. In addition, the pedal body 10 is rotatable against the axle 20. Further, a hexagonal tool driving portion 25 is disposed on the outer side of the second end 23, as shown by FIG. 3, such that the tool driving portion 25 is driven by a tool 300 such as a hexagonal wrench, as shown by FIG. 5. As a result, the first end 22 is optionally fastened to the crank 200 or loosened from the crank 200. Furthermore, a shoulder 27 is disposed on the axle 20 adjacent to the threaded section 24.

A friction-resisting piece 30 is made of iron material and mounted around the first end 22 of the axle 20 for preventing the friction between the pedal body 10 and the crank 200. Also, the friction-resisting piece 30 includes an inner blocking ring 31 for being combined to the shoulder 27 of the axle 20.

In addition, the pedal body 10 includes a first surface 40 and a second surface 50 opposite to the first surface 40. Two sides of the first surface 40 against the axle 20 are provided with plural first anti-slipping stripes 41, respectively, and two sides of the second surface 50 against the axle 20 are provided with plural second anti-slipping stripes 51, respectively, so as to increase the frictional force of the first surface 40 and the second surface 50. Also, two ends of each first anti-slipping stripe 41 are connected with two ends of each corresponding second anti-slipping stripe 51 through a connecting section 60, respectively.

The first anti-slipping stripes 41 and the second anti-slipping stripes 51 are arranged in parallel to the central axis of the axle 20. Preferably, each first anti-slipping stripe 41 and each second anti-slipping stripe 51 are provided with plural protrusions 70 equidistantly spaced. The protrusions 70 are also formed in a stripe shape and arranged in parallel to the central axis of the axle 20.

With the foregoing configuration, operation of the present invention will be illustrated below.

First, the first end 22 of the axle 20 is inserted into the axle bore 11 of the pedal body 10, such that one side of the pedal body 10 resists against the blocking portion 26 of the second end 23. Next, the friction-resisting piece 30 is mounted around the first end 22 of the axle 20. Then, the first end 22 of the axle 20 is screwedly mounted to the crank 200. Meanwhile, by driving the second end 23 of the tool driving portion 25 by use of the tool 300, the first end 22 is fastened to the crank 200, enabling the bicycle pedal 100 of the embodiment of the present invention to be used by the user for driving the bicycle.

On the other hand, if the bicycle pedal 100 is to be uninstalled from the crank 200 due to the maintenance of the damaged components thereof, the tool 300 is used to driving the tool driving portion 25 of the second end 23, such that the first end 22 is detached from the crank 200, whereby the bicycle pedal 100 is uninstalled.

Driving the tool driving portion 25 by use of the tool 300, the embodiment of the present invention enables the first end 22 of the axle 20 to be fastened to the crank 200 or be loosened from the crank 200, facilitating the installation and uninstallation of the bicycle pedal 100, thus meeting convenience of usage. Also, the axle 20 provided by the embodiment of the present invention is formed in a straight column shape. Compared with the known cone-shaped axle, the axle 20 herein provided enhances the structural strength of the overall pedal body 10.

Furthermore, by disposing the resilient member 12, when the user pedals the bicycle pedal 100, a vibration absorption and buffering effect is achieved. Also, the axle 20 and the resilient member 12 contact each other by multiple contact points between the axle 20 and the resilient member 12, such that the resilient member 12 substitutes the traditional bearing member. As a result, the amount of the components of the bicycle pedal 100 provided by the embodiments of the present invention is relative less than the amount of the traditional pedal components, thus lowering the overall cost and meeting economical demand.

In addition, the embodiment of the present invention includes the friction-resisting piece 30 mounted around the first end 22 of the axle 20. The friction-resisting piece 30 is disposed between the pedal body 10 and the crank 200, preventing the friction between the pedal body 10 and the crank 200 from occurring and thereby lowering the components wearing issues caused by the friction.

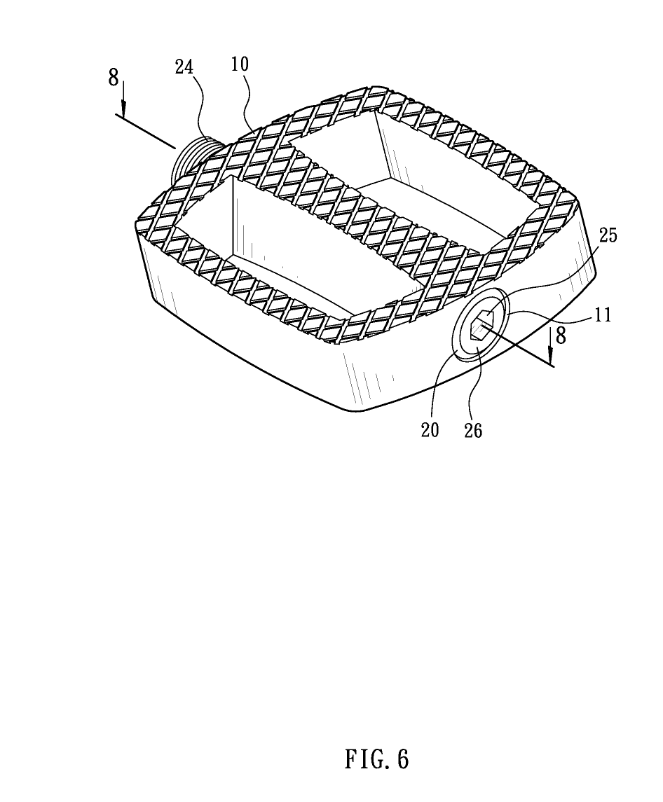

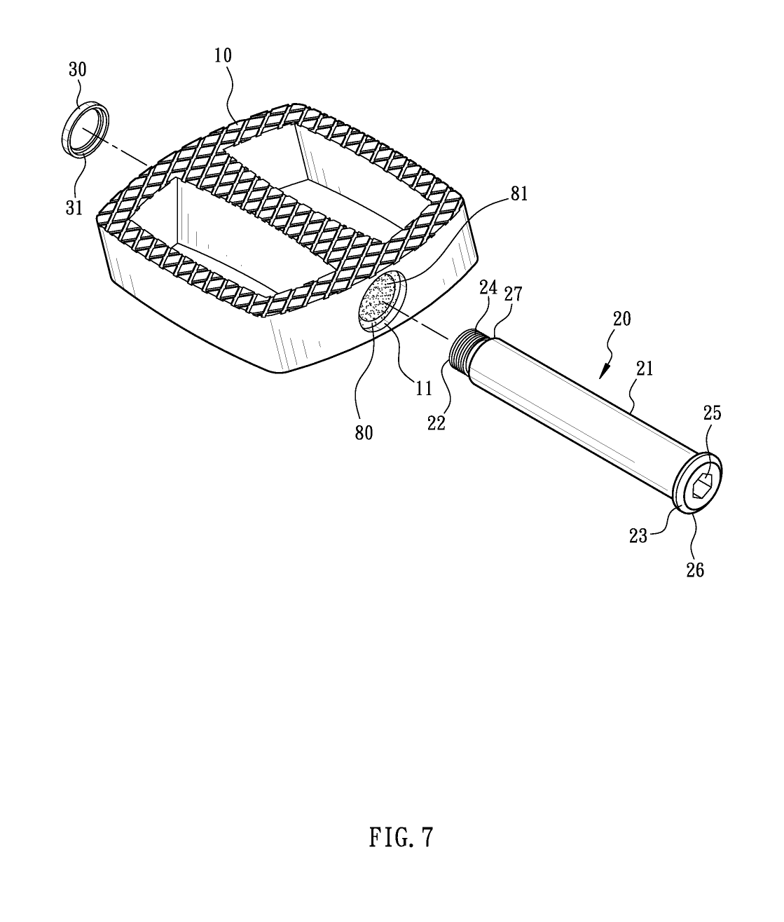

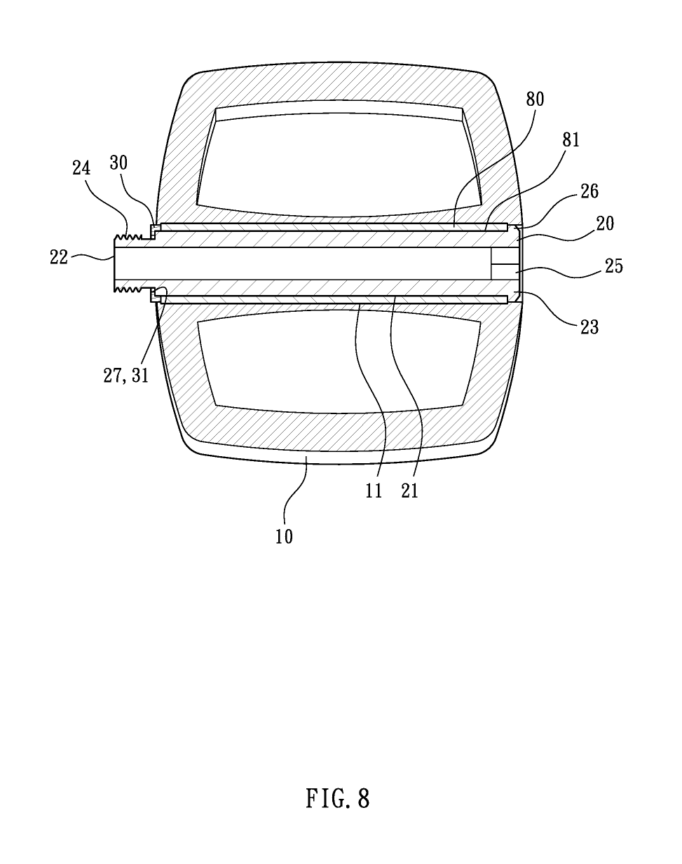

Referring to FIG. 6 to FIG. 8, another embodiment of the present invention is provided, wherein the elements with the numeric identical to the numeric in prior drawings refer to the identical or similar elements aforementioned in this specification. The alternative embodiment of the bicycle pedal 100 provided by the present invention comprises a pedal body 10, an axle 20, a friction-resisting piece 30, and a lining tube 80.

The lining tube 80 is disposed in the axle bore 11 and integrally formed with the pedal body 10. The lining tube 80 includes a smooth inner bore 81 with is arranged in axial alignment with the axle bore 11. Also, in the embodiment of the present invention, the lining tube 80 is made of self-lubricating engineering plastic material, such as PE, PEEK, and PP material.

The axle 20 is hollow and straight formed and passes through the inner bore 81 of the lining tube 80, such that the pedal body 10 is allowed to rotate against the axle 20. The blocking portion 26 of the axle 20 resists against one end of the lining tube 80 away from the crank 200 and does not protrude outward from the pedal body 10.

The friction-resisting piece 30, when being assembled, is partially received in the axle bore 11 and connected with the other end of the lining tube 80. Also, the friction-resisting piece 30 partially protrudes inward from the pedal body 10. The friction-resisting piece 30 adjusts the distance between the pedal body 10 and the crank 200; also, the friction-resisting piece 30 prevents the friction between the pedal body 10 and the crank 200 from occurring.

By use of the lining tube 80 integrally formed with the pedal body 10, during the installation of the pedal, no additional bearing structure is needed. Instead, the lining tube 80 substitutes the known bearing member. Therefore, the overall components of the bicycle pedal 100 are simplified, the installation process is facilitated, and the overall cost is lowered.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bicycle pedal, rotatably installed on a crank of a bicycle, comprising:
a pedal body including an axle bore transversely passing through two ends thereof; and
an axle formed in a straight column shape, passing through the axle bore, and provided with a first end and a second end, the first end screwedly mounted to the crank, the second end including a blocking portion resisting against an outer edge of the pedal body, the pedal body rotating against the axle, a tool driving portion disposed on an outer side of the second end.

2. The bicycle pedal of claim 1, wherein a resilient member is disposed on an inner periphery of the axle bore, and the resilient member includes a through hole through where the axle passes.

3. The bicycle pedal of claim 2, wherein the pedal body is made of a plastic material, and the resilient member is integrally formed in the axle bore when the pedal body is formed by injection molding.

4. The bicycle pedal of claim 2, wherein the resilient member is a spring, such that the axle and the resilient member contact each other by multiple contact points between the axle and the resilient member.

5. The bicycle pedal of claim 1, wherein the axle includes a straight section between the first end and the second end, the straight section disposed in the axle bore, the first end and the second end protruding from the pedal body.

6. The bicycle pedal of claim 5, wherein an outer diameter of the first end is smaller than a diameter of the straight section, and an outer diameter of the second is larger than the diameter of the straight section.

7. The bicycle pedal of claim 1, further comprising a friction-resisting piece mounted around the first end and preventing a friction between the pedal body and the crank.

8. The bicycle pedal of claim 1, wherein the tool driving portion is formed in a hexagonal bore and driven by a hexagonal wrench.

9. The bicycle pedal of claim 1, wherein the pedal body includes a first surface and a second surface opposite to the first surface, the first surface and the second surface provided with plural first anti-slipping stripes and second anti-slipping stripes, respectively, for increasing a frictional force of the first surface and the second surface, respectively.

10. The bicycle pedal of claim 9, wherein the first anti-slipping stripes and the second anti-slipping stripes are arranged in parallel to a central axis of the axle.

11. The bicycle pedal of claim 10, wherein the first anti-slipping stripes are disposed on two sides of the first surface against the axle, and the second anti-slipping stripes are disposed on two sides of the second surface against the axle.

12. A bicycle pedal, rotatably installed on a crank of a bicycle, comprising:
a pedal body including an axle bore transversely passing through two ends thereof; and
an axle formed in a straight column shape, passing through the axle bore, and provided with a first end and a second end, the first end screwedly mounted to the crank, the second end including a blocking portion resisting against an outer edge of the pedal body, the pedal body rotating against the axle, a tool driving portion disposed on an outer side of the second end;
a resilient member disposed in an inner periphery of the axle bore provided with a through hole through where the axle passes; and
a friction-resisting piece mounted around the first end and preventing a friction between the pedal body and the crank.

13. A bicycle pedal, comprising:
a pedal body including an axle bore transversely passing through two ends thereof;
a lining tube disposed in the axle bore and integrally molded with the pedal body, the lining tube including a smooth inner bore arranged in axial alignment with the axle bore; and
an axle passing through the inner bore, enabling the pedal body to rotate against the axle, and provided with a first end and a second end opposite to the first end, the first end including a threaded section to be screwedly mounted to a crank of a bicycle, the second end including a blocking portion resisting against an end of the lining tube away from the crank, the second end further including a tool driving portion.

14. The bicycle pedal of claim 13, wherein the axle is hollow.

15. The bicycle pedal of claim 13, further comprising a friction-resisting piece mounted around the first end of the axle, the friction-resisting piece partially received in the axle bore and connected with another end of the lining tube.

16. The bicycle pedal of claim 15, wherein a shoulder is disposed on the axle adjacent to the threaded section, the friction-resisting piece formed in a ring shape and including an inner blocking ring which is combined to the shoulder.

17. The bicycle pedal of claim 13, wherein the lining tube is made of a self-lubricating engineering plastic material.

18. The bicycle pedal of claim 13, wherein the blocking portion does not protrude from the pedal body.
